(19) United States
(12) Patent Application Publication
(10) Pub. No.: US 2025/0280825 A1
(43) Pub. Date: Sep. 11, 2025

(54) SYSTEMS AND METHODS FOR FAST DISINFECTING WIPES

(71) Applicant: THE CLOROX COMPANY, Oakland, CA (US)

(72) Inventors: Xuanrong GUO, Pleasanton, CA (US); Evan RUMBERGER, Pleasanton, CA (US); Megan RUMLEY, Miami, FL (US); Sara QUERO, Pleasanton, CA (US)

(21) Appl. No.: 18/597,413

(22) Filed: Mar. 6, 2024

(51) Int. Cl. A01N 33/12; A01N 25/30; A01N 25/34; A01N 31/02; A01P 1/00; A01P 3/00

(52) U.S. Cl. CPC A01N 33/12; A01N 25/30; A01N 25/34; A01N 31/02; A01P 1/00; A01P 3/00

(57) ABSTRACT

Disclosed embodiments include a pre-loaded cleaning wipe. A pre-loaded cleaning wipe may comprise a non-woven substrate and a formulation loaded onto the substrate. The formulation may include (i) about 10% to 40% by weight of an alcohol, (ii) about 0.01% to less than 0.7% by weight of a quaternary amine compound, and (iii) about 0.1% to 2% by weight of a surfactant. Optionally, the formulation may include one or more adjuncts comprising one or more of: fragrance, colorant, solvent, polymer, acid, water, pH adjusting agents or any mixture or combination thereof. Lastly, the formulation may exhibit at least a 3-log reduction in Staphylococcus aureus and/or Candida Auris population within 2 minutes.

### BACKGROUND OF THE INVENTION

### 1. The Field of the Invention

The present invention relates to pre-loaded cleaning wipes for use against bacteria, viruses and/or fungi. Such pre-loaded cleaning wipes may include a substrate and formulation loaded onto the substrate.

### 2. Description of Related Art

Pre-loaded cleaning wipes are commercially available and widely used. Existing pre-loaded cleaning wipes, however, include high amounts of alcohol, high amounts of quaternary amine compounds, or are incapable of providing sanitization against Staphylococcus aureus and/or Candida auris within a short time period (e.g., 2 minutes). Products with high alcohol content and/or high quaternary amine compound content pose a number of disadvantages. For example, high alcohol content and/or high quaternary amine compound content increases the overall cost of manufacturing compositions and the cost of goods itself. Additionally, high alcohol content results in transportation and manufacturing limitations due to the increased flammability of the product. High concentration of quaternary amine compounds in such formulations result in increased risk of irritation to skin, etc.

Current pre-loaded cleaning wipes with relatively low concentrations of alcohol and/or quaternary amine compound require longer contact times to be effective against various desired target bacteria and/or viruses, and are often completely ineffective against a target fungus (e.g., yeast) such as Candida auris.

### BRIEF SUMMARY

This summary is provided to introduce a selection of concepts in a simplified form where such concepts are further described below in the detailed description. This summary is not intended to identify key features or essential features of the claimed subject matter, nor is it intended to be used as an indication of the scope of the claimed subject matter.

An embodiment of the present disclosure relates to a pre-loaded cleaning wipe including: (A) a non-woven substrate; and (B) a formulation loaded onto the substrate including: (i) about 10% to 40% by weight of an alcohol; (ii) about 0.01% to less than 0.7% by weight of a quaternary amine compound; (iii) about 0.1% to about 2% by weight of a surfactant; (iv) optionally, one or more adjuncts comprising at least one of: fragrance, colorant, solvent, polymer, acid, water, pH adjusting agents or any mixture or combination thereof; and wherein the formulation exhibits at least a 3-log reduction in a Staphylococcus aureus population within 2 minutes.

Another embodiment of the present disclosure relates to a pre-loaded cleaning wipe including: (A) a non-woven substrate; and (B) a formulation loaded onto the substrate including: (i) about 10% to less than 40% by weight of an alcohol; (ii) about 0.01% to less than 1.5% by weight of a quaternary amine compound; (iii) about 0.1% to about 2% by weight of a surfactant; (iv) about 0.5% to about 5% by weight of a glycol ether; (v) optionally, one or more adjuncts comprising at least one of: fragrance, colorant, solvent, polymer, acid, water, pH adjusting agents or any mixture or combination thereof; and wherein the formulation exhibits at least a 3-log reduction in a Candida auris population within 2 minutes.

Another embodiment of the present disclosure relates to a pre-loaded cleaning wipe including: (A) a non-woven substrate; and (B) a formulation loaded onto the substrate including: (i) about 25% to less than 40% by weight of an alcohol; (ii) about 0.01% to less than 2.0% by weight of a quaternary amine compound; (iii) about 0.1% to about 2% by weight of a surfactant; (iv) about 0.5% to about 5% by weight of a glycol ether; (v) optionally, one or more adjuncts comprising at least one of: fragrance, colorant, solvent, polymer, acid, water, pH adjusting agents or any mixture or combination thereof; and wherein the formulation exhibits at least a 3-log reduction in a Staphylococcus aureus population within 2 minutes and has a pH of about 2 to about 4.

In any of the described embodiments, the formulation may include a glycol ether solvent.

In any of the described embodiments, the formulation may include about 25% to 40% by weight of an alcohol.

In any of the described embodiments, the formulation may have a pH of about 1 to about 5, or from about 2 to about 4.

In any of the described embodiments, the formulation may further include a fatty acid, e.g., such as octanoic acid or another C₈-C₁₂ fatty acid. Mixtures of various fatty acids are of course possible.

In any of the described embodiments, the formulation may further include an inorganic acid.

In any of the described embodiments, the formulation may further include an organic acid. In an embodiment, such an organic acid may include octanoic acid.

In any of the described embodiments, the formulation may exhibit at least a 5-log reduction in a Staphylococcus aureus population within 2 minutes.

In any of the described embodiments, the formulation may exhibit at least a 3-log reduction in a Candida auris population within 2 minutes.

In any of the described embodiments, the formulation may further include an acid.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims or may be learned by the practice of such exemplary implementations as set forth hereinafter.

### DETAILED DESCRIPTION OF THE PREFERRED EMBODIMENTS

### I. DEFINITIONS

Before describing the present invention in detail, it is to be understood that this invention is not limited to particularly exemplified systems or process parameters that may, of course, vary. It is also to be understood that the terminology used herein is for the purpose of describing particular embodiments of the invention only and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

As used herein, the term “between” is inclusive of any endpoints noted relative to a described range.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

As used herein, “disposable” is used in its ordinary sense to mean an article that is disposed or discarded after a limited number of usage events, preferably less than 25, more preferably less than about 10, and most preferably after a single usage event. The wipes disclosed herein are typically disposable.

As used herein, the term “substrate” is intended to include any material that is used to clean an article or a surface. Examples of cleaning substrates include, but are not limited to, wipes, mitts, pads, or a single sheet of material which is used to clean a surface by hand or a sheet of material which can be attached to a cleaning implement, such as a floor mop, handle, or a handheld cleaning tool, such as a toilet cleaning device. The term “substrate” is also intended to include any material that is used for personal cleansing applications. These substrates can be used for hard surface, soft surface, and personal care applications. Such substrates may typically be in the form of a wipe.

Such substrates may be formed of a structure of individual fibers which are interlaid, typically in a manner that is not identifiable (e.g., a nonwoven). The nonwoven substrates, or layers used to make up such a nonwoven substrate included in the present substrates may be formed by any suitable process. For example, they may be meltblown, spunbond, spunlaid, SMS (spunbond-meltblown-spunbond), coform, carded webs, thermal bonded, thermoformed, spunlace, hydroentangled, hydroembossed, needled, or chemically bonded. Various processes for forming such nonwovens will be apparent to those of skill in the art, many of which are described in U.S. Pat. No. 7,696,109, incorporated herein by reference in its entirety. EP Applications EP992338, EP1687136, EP1861529, EP1303661, and US2004/0157524 are also herein incorporated by reference, each in its entirety. These references describe various nonwoven structures which are generally illustrative, and which may be modified by using the contemplated plant-based renewable biodegradable and/or compostable fibers described herein rather than the synthetics typically employed in the prior art. Where the employed fibers are not thermoplastic (e.g., various pulp or cellulose derivatives), the processes used to form the nonwoven may of course not rely on melt-softening or thermoplasticity. Spunlace and hydroentangling are non-limiting examples of such processes.

The terms “wipe”, “substrate” and the like may thus overlap in meaning, and while “wipe” may typically be used herein for convenience, it will be appreciated that this term may often be interchangeable with “substrate”.

As used herein, “wiping” refers to any shearing action that the wipe undergoes while in contact with a target surface. This includes hand or body motion, substrate-implement motion over a surface, or any perturbation of the substrate via energy sources such as ultrasound, mechanical vibration, electromagnetism, and so forth.

The formulation may provide sanitization, disinfection, or sterilization, other cleaning, or other treatment. As used herein, the term “sanitize” shall mean the reduction of “target” contaminants in the inanimate environment to levels considered safe according to public health ordinance, or that reduces a “target” bacterial population by significant numbers where public health requirements have not been established. By way of example, an at least 99% reduction in bacterial population within a 24-hour time period is deemed “significant.” Greater levels of reduction (e.g., 99.9%, 99.99%, etc.) are possible, as are faster treatment times (e.g., within 10 minutes, within 5 minutes, within 4 minutes, within 3 minutes, within 2 minutes, or within 1 minute), when sanitizing or disinfecting.

As used herein, the term “disinfect” shall mean the elimination of many or all “target” pathogenic microorganisms on surfaces with the exception of bacterial endospores.

As used herein, the term “sterilize” shall mean the complete elimination or destruction of all forms of “target” microbial life and which is authorized under the applicable regulatory laws to make legal claims as a “sterilant” or to have sterilizing properties or qualities.

Some embodiments may provide for at least a 2 or more log reduction (e.g., 3-log reduction, 4-log reduction, 5-log reduction, or 6-log reduction) in a bacterial population within a designated time period (e.g., 10 minutes, 5 minutes, 4 minutes, 3 minutes, 2 minutes, 1 minute, 30 seconds, or the like) relative to a baseline. A 2-log reduction is equivalent to a 99% reduction, a 3-log reduction is equivalent to at least a 99.9% reduction, a 4-log reduction is equivalent to at least a 99.99% reduction, a 5-log reduction is equivalent to at least a 99.999% reduction, etc. An example of a target microbe may be Staphylococcus aureus and/or Candida auris. It will be appreciated that antimicrobial efficacy can also be achieved against other target microbes, numerous examples of which will be apparent to those of skill in the art.

The term “Safer Choice” means the U.S. EPA program that is focused on identifying safer sanitizing and disinfecting active ingredients. The EPA has a special approval process for products that meet the Safer Choice criteria. The EPA, as part of the Safer Choice program has identified certain active ingredients that are approved for cleaning products and authorized to use the Safer Choice logo. Products that have been approved may be found under https://www.epa.gov/pesticide-labels/design-environment-logo-antimicrobial-pesticide-products#authorizeddfe. Approved products must have only ingredients that meet the “Safer Choice Standard” according to https://www.epa.gov/pesticide-labels/design-environment-logo-antimicrobial-pesticide-products#approved and https://www.cpa.gov/saferchoice/safer-choice-standard. The above EPA publications are herein incorporated by reference in their entirety.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

Reference to ASTM or other standards or standardized tests refers to the latest version of such standard, unless otherwise specified. Standards referenced herein are herein incorporated by reference in their entirety.

### II. EXEMPLARY PRE-LOADED CLEANING WIPES AND FORMULATIONS

In an aspect, the present invention is directed to pre-loaded cleaning wipes that include a non-woven substrate and a formulation loaded onto the substrate. The formulation may include at least an alcohol, a quaternary amine compound, and a surfactant. In some embodiments, the formulation may also include a glycol ether, an organic acid, an inorganic acid, a fatty acid, and/or one or more adjuncts. Embodiments may have a pH of about 1 to about 5, or from about 2 to about 4, and exhibit at least a 3-log reduction in Staphylococcus aureus and/or a Candida auris population within 2 minutes. Additionally, the present disclosure may be effective against other microbial targets that may include viruses (e.g., phi 6, SARS-Covid surrogates, a norovirus surrogate such as Feline calicivirus (FCV)) and other pathogenic bacteria, bacteriophages, or fungi (e.g., A. niger, MS2, etc.).

### A. Non-Woven Substrate

In an aspect, the present invention is directed to pre-loaded nonwoven substrates. The fibers and/or nonwoven may be formed by any suitable technique, e.g., including but not limited to meltblown, spunbond, spunlaid, SMS (spunbond-meltblown-spunbond), coform, carded webs, thermal bonded, thermoformed, spunlace, hydroentangled, hydroembossed, needled, or chemically bonded, and any combinations thereof. In an embodiment, the nonwoven may be spunlace, or another process that does not rely on melt-softening or thermoplasticity, where the employed fibers are cellulose or other pulp materials or derivatives thereof, such as viscose, rayon or lyocell. Of course, melt-softened thermoplastic materials may also be employed. Nonlimiting examples of some possible suitable materials include polyethylene, polypropylene, PET, PVC, polyacrylics, polyamides, polystyrenes, and the like. In an embodiment, the nonwoven substrate may be specifically formed from materials that are more environmentally friendly as compared to the non-renewable, non-biodegradable, non-compostable materials typically employed as synthetic fibers in such wipes. For example, biodegradable or compostable polyesters, polyvinyl alcohols, or polyvinyl acetates (e.g. PHA, PVOH, PVA, and/or PLA) may be employed. In addition, the substrate, or the entire combination, i.e., the loaded wipe as a whole, may meet applicable compostability requirements (e.g., ASTM D6400, EN13432, ASTM D5338, ASTM D5271 or the like).

In embodiments, the nonwoven substrate may be comprised of multiple layers (e.g., 2 or 3 layers). In other embodiments, the substrate may be formed from a single layer. Where different layers are present, the initially separate layers may be bonded to one another through any of various suitable techniques that will be apparent to those of skill in the art. For example, hydroentangling, needling or any other technique may be used to bond such layers to one another. Adhesives may also be used, although in an embodiment, no adhesives are employed.

No matter the process by which the dry nonwoven substrate is formed, once formed, a desired cleaning composition may be loaded onto the nonwoven substrate.

Pulp and/or other natural fibers or derivatives of natural fibers (e.g., regenerated cellulose), may be incorporated into such substrates.

The basis weight of the nonwoven substrates or individual layers thereof may be expressed in grams per square meter (gsm), and may be, for example, no more than 200 gsm, no more than 150 gsm, no more than 100 gsm, such as from 5 to 80 gsm, or from 10 to 60 gsm.

It will be appreciated that the present wipes may include any of various textures, or perhaps no texture at all.

It may be advantageous that any processing that the nonwoven substrate undergoes (e.g., calendaring, drying, or the like), be at a temperature that is sufficiently low to ensure that any pulp or other plant-based natural or naturally derived fibers do not ignite, or become embrittled or discolored due to “burning”, which may occur near the paper ignition temperature of 233° C.

The nonwoven substrates may be packaged within any desired container system. Examples of such include, but are not limited to flex packs, cylinders, tubs, or other containers for storage and dispensing. The wipes may typically be pulled through an orifice such as typically provided with such containers, without fear of shredding or delamination of any included layers, even where all or nearly all of the fibers of the nonwoven substrate comprise pulp or other fibers derived from a plant-based natural source.

In some embodiments, it may be desirable to provide the substrate with a lofted structure, to increase the bulk and thickness of the substrate, where such lofted characteristics may not otherwise be provided, particularly by synthetic fibers. Such lofting may be provided by any suitable technique that may increase the bulk and thickness of the layer, by adding lofted material thereto, which includes gaps, air pockets, and/or a fuzzy, lofted characteristic.

### B. Formulation

### i. Quaternary Amine Compounds

In an aspect, the formulation may include a quaternary amine compound. The quaternary amine compound may act as an antimicrobial agent, in combination with the included alcohol content. For example, the quaternary amine compound may be included in an amount greater than 0%, such as from 0.01%, from 0.05%, from 0.1%, from 0.2%, from 0.3%, up to 5%, up to 3%, up to 2%, up to 1.5%, up to 1%, up to 0.7%, up to 0.65%, up to 0.6%, or up to 0.5% by weight of the formulation. In an embodiment, the quaternary amine compound may include two or more quaternary amine compounds.

Quaternary amine compounds have broad spectrum antimicrobial properties. A variety of different quaternary amine compounds can be used in the formulation. Non-limiting examples of quaternary amine compounds are typically halides (e.g., a chloride) of alkyldimethylbenzylammonium, alkyldimethylethylbenzylammonium, alkyldimethylammonium, dodecyldimethylammoniumchloride, or the like. The alkyl groups of such quaternary amine compounds may typically range from C₁₂ to C₁₈. Quaternary amine compounds are described in more detail in U.S. Pat. No. 6,825,158, incorporated by reference herein, and will already be familiar to those of skill in the art.

As noted above, limiting the concentration of the included quaternary amine compound is an important characteristic of at least some embodiments of the present invention, as elevated levels can result in increased skin irritation and other disadvantages. The ability to provide fast (e.g., within 2 minutes) sanitization against a desired target microbe, while only employing a relatively low concentration of the quaternary amine compound is particularly advantageous. For example, in an embodiment, the concentration is no greater than 0.7% by weight.

### ii. Surfactants

Those of skill in the art will appreciate that any among a wide variety of surfactants (e.g., anionic, cationic, non-ionic, zwitterionic, and/or amphoteric) may be included in the formulation, as desired, so long as the resulting loaded wipe can meet the stated antimicrobial efficacy standards. In an embodiment, nonionic and/or amphoteric surfactants are particularly preferred. In an embodiment, the formulation may be free or substantially free of anionic surfactants. In an embodiment any included surfactants are selected from the group consisting of or consisting essentially of nonionic and/or amphoteric surfactants. While the quaternary amine compound may sometimes be used as a cationic surfactant, that is not the function for which it is included in the present formulations. Where included, a surfactant may be present from 0.01%, from 0.02%, from 0.03%, from 0.05%, from 0.1%, from 0.2%, from 0.3%, from 0.5%, up to 10%, up to 5%, up to 4%, up to 3%, up to 2%, or up to 1% by weight of the formulation. Various surfactants and other optional adjuvants are disclosed in U.S. Pat. No. 3,929,678 to Laughlin and Heuring, U.S. Pat. No. 4,259,217 to Murphy, U.S. Pat. No. 5,776,872 to Giret et al.; U.S. Pat. No. 5,883,059 to Furman et al.; U.S. Pat. No. 5,883,062 to Addison et al.; U.S. Pat. No. 5,906,973 to Ouzounis et al.; U.S. Pat. No. 4,565,647 to Llenado, and U.S. Publication No. 2013/0028990. The above patents and applications are each herein incorporated by reference in their entirety.

Examples of nonionic surfactants include, but are not limited to, alcohol ethoxylates, alcohol propoxylates, other alcohol alkoxylates including fatty (e.g., C₆, C₈, C₁₀, or C₁₂, or higher) alcohols or other constituents that have been alkoxylated to include both ethoxy and propoxy groups (EO-PO surfactants), alkyl phosphine oxides, alkyl glucosides (i.e., alkyl glycosides) and alkyl pentosides, alkyl glycerol esters, alkyl ethoxylates, and alkyl and alkyl phenol ethoxylates of all types, poly alkoxylated (e.g. ethoxylated or propoxylated) C₆-C₁₂ linear or branched alkyl phenols, C₆-C₂₂ linear or branched aliphatic primary or secondary alcohols, C₂-C₈ linear or branched aliphatic glycols, and tergitol. Block or random copolymers of C₂-C₆ linear or branched alkylene oxides may also be suitable nonionic surfactants. Capped nonionic surfactants in which the terminal hydroxyl group is replaced by halide; C₁-C₈ linear, branched, or cyclic aliphatic ether; C₁-C₈ linear, branched or cyclic aliphatic ester; phenyl, benzyl or C₁-C₄ alkyl aryl ether; or phenyl, benzyl or C₁-C₄ alkyl aryl ester may also be used. Sorbitan esters and ethoxylated sorbitan esters may also be useful nonionic surfactants. Other suitable nonionic surfactants may include mono or polyalkoxylated amides of the formula R¹CONR²R³ and amines of the formula R¹NR²R³ wherein R¹ is a C₅-C₃₁ linear or branched alkyl group and R² and R³ are C₁-C₄ alkyl, C₁-C₄ hydroxyalkyl, or alkoxylated with 1-3 moles of linear or branched alkylene oxides. Biosoft 91-6 (Stepan Co.) is an example of an alkyl ethoxylate (or alcohol ethoxylate) having a methylene chain length of C₉ to C₁₁ with an average of 6 moles of ethoxylation. An example of an alcohol ethoxylate is ECOSURF EH-9, which is more specifically an ethylene oxide-propylene oxide copolymer mono(2-ethylhexyl) ether, available from Sigma-Aldrich.

Alkylpolysaccharide nonionic surfactants are disclosed in U.S. Pat. No. 4,565,647 to Llenado, having a linear or branched alkyl, alkylphenyl, hydroxyalkyl, or hydroxyalkylphenyl group containing from 6 to 30 carbon atoms and a polysaccharide, e.g., a polyglycoside, hydrophilic group containing from 1.3 to 10 saccharide units. Suitable saccharides may include, but are not limited to, glucosides, galactosides, lactosides, and fructosides. Alkylpolyglycosides may have the formula: R²O(CnH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 10.

Fatty acid saccharide esters and alkoxylated fatty acid saccharide esters may also be suitable for use in the present invention. Examples include, but are not limited to, sucrose esters, such as sucrose cocoate, and sorbitan esters, such as polyoxyethylene(20) sorbitan monooleate and polyoxyethylene(20) sorbitan monolaurate.

Phosphate ester surfactants may also be suitable. These include mono, di, and tri esters of phosphoric acid with C₄-C₁₈ alkyl, aryl, alkylaryl, alkyl ether, aryl ether and alkylaryl ether alcohols (e.g. disodium octyl phosphate).

Zwitterionic or amphoteric surfactants may be suitable. As zwitterionic or amphoteric surfactants include both a positive and negative functional group, they may also be classified as nonionic surfactants. Many such zwitterionic or amphoteric surfactants contain nitrogen. Examples of such include amine oxides, sarcosinates, taurates and betaines. Examples include C₈-C₁₈ alkyldimethyl amine oxides (e.g., octyldimethylamine oxide, lauryldimethylamine oxide (also known as lauramine oxide), and cetyldimethylamine oxide), C₄-C₁₆ dialkylmethylamine oxides (e.g. didecylmethylamine oxide), C₈-C₁₈ alkyl morpholine oxide (e.g. laurylmorpholine oxide), tetra-alkyl diamine dioxides (e.g. tetramethyl hexanane diamine dioxide, lauryl trimethyl propane diamine dioxide), C₈-C₁₈ alkyl betaines (e.g. decylbetaine and cetylbetaine), C₈-C₁₈ acyl sarcosinates (e.g. sodium lauroylsarcosinate), C₈-C₁₈ acyl C₁-C₆ alkyl taurates (e.g. sodium cocoylmethyltaurate), C₈-C₁₈ alkyliminodipropionates (e.g. sodium lauryliminodipropionate), and combinations thereof. Lauryl dimethyl amine oxide (Ammonyx LO) myristyl dimethyl amine oxide (Ammonyx MO), decylamine oxide (Ammonyx DO) are examples of suitable zwitterionic or amphoteric surfactants, available from Stepan Co.

Non-limiting examples of anionic surfactants include alkyl sulfates (e.g., C₈-C₁₈ linear or branched alkyl sulfates such as sodium lauryl sulfate (SLS), and sodium tetradecylsulfate), alkyl sulfonates (e.g., C₆-C₁₈ linear or branched alkyl sulfonates such as sodium octane sulfonate and secondary alkane sulfonates, alkyl ethoxysulfates, fatty acids and fatty acid salts (e.g., C₆-C₁₆ fatty acid soaps such as sodium laurate), alkyl amino acid derivatives, and texapon. Other examples may include sulfate derivatives of alkyl ethoxylate propoxylates, alkyl ethoxylate sulfates, alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methylsulfonates, C₆-C₁₈ alkyl, aryl, or alkylaryl ether carboxylates, sulfonated alkyldiphenyloxides (e.g. sodium dodecyldiphenyloxide disulfonate), and the like. In an embodiment, the formulation may be free, or substantially free of such anionic surfactants.

More specific examples of nonionic and/or zwitterionic or amphoteric surfactants include lauryl dimethyl amine oxide (Ammonyx LO), also known as lauramine oxide, myristyl dimethyl amine oxide (Ammonyx MO), decylamine oxide (Ammonyx DO), other amine oxides, any betaines, linear alcohol ethoxylates, alcohol propoxylates, alkyl polyglucosides, natrasense, and combinations thereof.

### iii. Organic Acids, Inorganic Acids, and Fatty Acids

Embodiments of the formulation may optionally include at least one of an organic acid, an inorganic acid, or a fatty acid.

In an embodiment, the organic acid is a short chain organic acid, e.g., having no more than 12, no more than 10, no more than 8, no more than 6, or no more than 4 carbon atoms. In an embodiment, the organic acid is a mono-organic acid (e.g., as opposed to a dicarboxylic or polycarboxylic acid). In an embodiment, the organic acid(s) may include citric acid, pyruvic acid, or others. In an embodiment, any organic, inorganic, or fatty acid is included at about 0.01%, about 0.05%, about 0.1%, about 0.2%, about 0.3%, about 0.5%, about 0.8%, about 1.0%, about 1.5%, about 2%, about 3% or about 5% by weight of the formulation. Ranges between any such values are also possible, e.g., from 0.01%, from 0.05%, from 0.1%, from 0.2%, from 0.3%, from 0.5%, up to 5%, up to 3%, up to 2%, up to 1.5%, or up to 1% by weight of the formulation.

In an embodiment, the inorganic acid includes phosphoric acid. The inorganic acid may be included in amounts of from about 0.05%, from about 0.1%, from about 0.3%, such as from about 0.05% to about 1%, from 0.05% to about 0.5%, or from about 0.1% to about 0.3% by weight of the formulation. In some embodiments, the fatty acid may include one or more of octanoic acid, lauric acid, and/or myristic acid, or other C₈ to C₁₂ acids. The fatty acid may be included in amounts of about 0.03%, about 0.05%, about 0.08%, about 0.1%, about 0.3%, or about 0.5%, such as from 0.03%, from 0.05%, from 0.08%, up to 1%, up to 0.5%, or up to 0.3% by weight of the formulation.

In another aspect, the pH of the formulation is kept low. A low pH can be important to achieve sanitization and/or disinfection efficacy. In some embodiments, the components may be most efficacious in the acid form compared to the conjugate base form. Therefore, a pH that provides a balance between microefficacy, aesthetics and toxicity levels is desirable.

By way of example, the pH may be at least 1, at least 1.5, at least 2, at least 3, up to 6, up to 5, up to 4, or up to 3. In an embodiment, the pH is maintained between about 1 to about 6, about 1 to about 5, about 2 to about 5, or about 1 to about 4. The pH may be maintained by the addition of a buffer. In some embodiments, the buffer includes citric acid.

In some embodiments, the citric acid is included as both a buffer and an organic acid. In other embodiments, the citric acid is included as an organic acid which further lowers the pH. The citric acid or other buffer may be included in an amount of at least about 0.05%, at least about 0.8%, at least about 0.9%, at least about 0.1%, up to about 3%, up to about 2%, up to about 1.5%, or up to about 1% by weight of the formulation.

### iv. Alcohols and Solvents

In an embodiment, the formulation may include an alcohol. For example, a lower alkyl alcohol (e.g., C₁-C₄ alcohols such as isopropanol (isopropanol alcohol anhydrous), ethanol, and/or t-butanol) may be present, e.g., particularly as an antimicrobial agent. Such a lower alcohol itself may be present in a significant amount, e.g., such as at least 10%, such as 10% to 40% by weight of the formulation. Additional alcohols may also be employed, e.g., diols, 1,2-hexanediol, 1,2-octanediol, monoethanolamine, 1-pentanol and the like. Combinations or mixtures of alcohols may be used. The cleaning formulation may include total alcohols in amounts of at least 10%, at least 20%, about 25%, about 30%, about 40%, about 50%, no more than 50%, no more than 40%, or no more than 30% by weight. Limiting the amount of alcohol to no more than 35% by weight can be advantageous, as above such threshold, more restrictive flammability, transportation, handling, manufacture, and other restrictions apply. The ability to achieve antimicrobial efficacy characteristics as described herein, while employing no more than 35% alcohol, particularly in combination with no more than 0.7% quaternary amine compound concentration, is particularly advantageous, and surprising.

In some embodiments, a solvent other than the lower alcohol may be present, such as a glycol ether solvent. Exemplary glycol ether solvents include, but are not limited to, ethylene glycol monopropyl ether, ethylene glycol monobutyl ether, ethylene glycol monohexyl ether, ethylene glycol phenyl ether, propylene glycol n-propyl ether, propylene glycol monobutyl ether, propylene glycol t-butyl ether, diethylene glycol monoethyl or monopropyl or monobutyl ether, di- or tri-polypropylene glycol methyl or ethyl or propyl or butyl ether, propylene glycol phenyl ether, ethylene glycol phenyl ether, acetate and/or propionate esters of glycol ethers. A glycol ether or other solvents may be included from 0.1%, from 0.25%, from 0.5%, up to 10%, up to 5%, up to 4%, up to 3%, up to 2%, or up to 1% by weight of the formulation. Other solvents, surfactants, and various other adjuvants often included in sanitization or disinfection formulations may optionally be present.

### v. Additional Adjuvants

The formulation may optionally include and/or be used in combination with one or more additional adjuncts. The adjuncts include, but are not limited to, fragrances, colorants, polymers, pH adjusting agents, waxes, solubilizing materials, stabilizers, thickeners, defoamers, hydrotropes, buffers, builders, lotions and/or mineral oils, enzymes, cloud point modifiers, preservatives, and/or chaotropic agents. In one embodiment, buffering and pH adjusting agents, when used, include, but are not limited to, organic acids, mineral acids, alkali metal and alkaline carth salts of citrate, silicate, metasilicate, polysilicate, borate, carbonate, carbamate, phosphate, polyphosphate, pyrophosphates, triphosphates, tetraphosphates, ammonia, hydroxide, monocthanolamine, monopropanolamine, diethanolamine, dipropanolamine, triethanolamine, and/or 2-amino-2methylpropanol.

A buffering agent can be a low molecular weight, organic or inorganic material used for maintaining the desired pH. For buffers that can be used, see Mccutcheon's EMULSIFIERS AND DETERGENTS, North American Edition, 1997, Mccutcheon Division, MC Publishing Company which is incorporated herein by reference. In yet another and/or alternative embodiment, solubilizing materials, when used, can include, but are not limited to, hydrotropes (e.g., water soluble salts of low molecular weight organic acids such as the sodium and/or potassium salts of xylene sulfonic acid).

In still another and/or alternative embodiment, thickeners, when used, include, but are not limited to, polyacrylic acid, xanthan gum, calcium carbonate, aluminum oxide, alginates, guar gum, methyl, ethyl, clays, and/or propylhydroxycelluloses. Polyacrylic acid is also an exemplary polymer adjunct. In yet another and/or alternative embodiment, defoamers, when used, include, but are not limited to, silicones, aminosilicones, silicone blends, and/or silicone/hydrocarbon blends. In still a further and/or alternative embodiment, preservatives, when used, include, but are not limited to, mildewstats or bacteriostats, methyl, ethyl and propyl parabens, short chain organic acids (e.g., acetic, lactic and/or glycolic acids), bisguanidine compounds (e.g., Dantagard and/or Glydant) and/or short chain alcohols (e.g., ethanol and/or IPA). In one aspect of this embodiment, the mildewstats or bacteriostats include, but are not limited to, mildewstats (including non-isothiazolone compounds) include Kathon GC, a 5-chloro-2-methyl-4-isothiazolin-3-one, Kathon ICP, a 2-methyl-4-isothiazolin-3-one, and a blend thereof, and Kathon 886, a 5-chloro-2-methyl-4-isothiazolin-3-one, all available from Rohm and Haas Company; Bronopol, a 2-bromo-2-nitropropane-1,3-diol, from Boots Company Ltd.; Proxel CRL, a propyl-p-hydroxybenzoate, from ICI PLC; Nipasol M, an o-phenyl-phenol, Na+ salt, from Nipa Laboratories Ltd.; Dowicide A, a 1,2-Benzoisothiazolin-3-one, from Dow Chemical Co.; and Irgasan DP 200, a 2,4,4′-trichloro-2-hydroxydiphenylether, from Ciba-Geigy A.G.

Fragrances may be included in an amount of at least 0.025%, at least 0.05%, up to 1%, up to 0.5%, or up to 0.1% weight of the formulation.

In an embodiment, the formulation may include a significant fraction of water, such as at least 40%, at least 45%, at least 50% at least 55%, at least 60%, at least 65%, or at least 70% water, such as no more than 90%, no more than 85%, no more than 80%, no more than 75%, or no more than 70% water. Such water may be present in free, unbound form.

In some respects, the antimicrobial formulation may exhibit at least a 3-log reduction against a target microbe. The target microbe may be Staphylococcus aureus and/or Candida auris. Additional exemplary target microbes include, but are not limited to Klebsiella pneumonia, Pseudomonas aeruginosa (Pseudo), A. niger, phi6, MS2, SARS-Covid surrogates or any of a wide variety of other pathogenic microbes or surrogate microbes. The formulation may exhibit such a log reduction against the target microbe within a very short exposure time frame, such as within 2 minutes. The ability to achieve such a reduction within a short period of time, particularly against fungal yeast such as Candida auris is particularly surprising (with the low levels of alcohol and quaternary amine).

### IV. EXAMPLES

The formulation pre-loaded onto the substrate includes at least an alcohol, a quaternary amine compound, and a surfactant. In some embodiments, the alcohol may be present from about 10% to about 50%, or 10% to about 40%, or at no more than 30% by weight. The quaternary amine compound may be present at from about 0.01% to about 2% by weight, no more than 1.5% by weight, or no more than 0.7% by weight. The surfactant may be present at from about 0.1% to about 2% by weight. Some embodiments further include a glycol ether present at about 0.5% to about 5% by weight. Additionally, the formulation in some embodiments further includes one or more acids, such as a fatty acid, an organic acid, and/or an inorganic acid. Adjuncts may include fragrance, colorant, solvent, polymer, acid, pH adjusting agents or any mixture of combination thereof. The balance of the formulation may be water (and is calculated as such in the tables below). The formulation may have a pH of about 1 to about 5 and exhibits at least a 3-log reduction in a Staphylococcus aureus and/or a Candida auris population within 2 minutes. Example formulations 001-085 are shown below in Tables 1A-1Q.

TABLE 1A

| | | 001 | 002 | 003 | 004 | 005 |
|---|---|---|---|---|---|---|
| Water | | 97.28% | 87.83% | 77.83% | 82.83% | 67.83% |
| Didecyl | Quaternary | 0.37% | 0.37% | 0.37% | 0.37% | 0.37% |
| Dimethyl | Amine | | | | | |
| Ammonium | Compound | | | | | |
| Chloride | | | | | | |
| Isopropanol | Alcohol | 0.45% | 10.00% | 20.00% | 15.00% | 30.0% |
| Alcohol | | | | | | |
| Anhydrous | | | | | | |
| Propylene | Solvent | 1.50% | 1.50% | 1.50% | 1.50% | 1.50% |
| glycol phenyl | | | | | | |
| ether | | | | | | |
| Alkyl | Nonionic | 0.30% | 0.30% | 0.30% | 0.30% | 0.30% |
| Polyglycoside | Surfactant | | | | | |
| Surfactant | | | | | | |
| Lemon Twist | Fragrance | 0.10% | | | | |
| Fragrance | | | | | | |

TABLE 1B

| | | 006 | 007 | 008 | 009 | 010 |
|---|---|---|---|---|---|---|
| Water | | 77.83% | 77.83% | 87.93% | 78.03% | 68.13% |
| Didecyl | Quaternary | 0.37% | 0.37% | 0.37% | 0.37% | 0.37% |
| Dimethyl | Amine | | | | | |
| Ammonium | Compound | | | | | |
| Chloride | | | | | | |
| Isopropanol | Alcohol | 10.00% | | | | |
| Alcohol | | | | | | |
| Anhydrous | | | | | | |
| 1-Pentanol | Alcohol | | | 9.9% | 19.8% | 29.7% |
| Ethanol | Alcohol | 10.00% | 20.00% | | | |
| Propylene | Solvent | 1.50% | 1.50% | 1.50% | 1.50% | 1.50% |
| glycol phenyl | | | | | | |
| ether | | | | | | |
| Alkyl | Nonionic | 0.30% | 0.30% | 0.30% | 0.30% | 0.30% |
| Polyglycoside | Surfactant | | | | | |
| Surfactant | | | | | | |

TABLE 1C

| | | 011 | 012 | 013 | 014 | 015 |
|---|---|---|---|---|---|---|
| Water | | 67.85% | 77.85% | 77.85% | 77.85% | 77.95% |
| Didecyl | Quaternary | 0.37% | 0.37% | 0.37% | 0.37% | 0.37% |
| Dimethyl | Amine | | | | | |
| Ammonium | Compound | | | | | |
| Chloride | | | | | | |
| Isopropanol | Alcohol | 28.00% | 18.00% | 18.00% | 18.00% | 18.00% |
| Alcohol | | | | | | |
| Anhydrous | | | | | | |
| 1-Pentanol | Alcohol | 1.98% | 1.98% | 1.98% | 1.98% | 1.98% |
| Propylene | Solvent | 1.50% | 1.50% | 1.50% | 1.50% | 1.50% |
| glycol phenyl | | | | | | |
| ether | | | | | | |
| Alkyl | Nonionic | 0.30% | 0.30% | | | |
| Polyglycoside | Surfactant | | | | | |
| Surfactant | | | | | | |
| Secondary | Nonionic | | | 0.30% | | |
| alcohol | Surfactant | | | | | |
| ethoxylate | | | | | | |
| Polyacrylic | Polymer | | | | 0.30% | 0.20% |
| Acid Polymer | | | | | | |

TABLE 1D

| | | 016 | 017 | 018 | 019 | 020 |
|---|---|---|---|---|---|---|
| Water | | 77.94% | 68.58% | 87.94% | 58.83% | 68.08% |
| Didecyl | Quaternary | 0.37% | 0.37% | 0.37% | 0.37% | 0.37% |
| Dimethyl | Amine | | | | | |
| Ammonium | Compound | | | | | |
| Chloride | | | | | | |
| Isopropanol | Alcohol | 19.00% | 30.00% | 9.00% | 40.00% | 30.00% |
| Alcohol | | | | | | |
| Anhydrous | | | | | | |
| 1-Pentanol | Alcohol | 0.99% | | 0.99% | | 0.50% |
| Propylene | Solvent | 1.50% | 0.75% | 1.50% | 0.50% | 0.75% |
| glycol phenyl | | | | | | |
| ether | | | | | | |
| Alkyl | Nonionic | | 0.30% | | 0.30% | 0.30% |
| Polyglycoside | Surfactant | | | | | |
| Surfactant | | | | | | |
| Secondary | Nonionic | 0.20% | | 0.20% | | |
| alcohol | Surfactant | | | | | |
| ethoxylate | | | | | | |

TABLE 1E

| | | 021 | 022 | 023 | 024 | 025 |
|---|---|---|---|---|---|---|
| Water | | 68.33% | 67.78% | 67.78% | 67.78% | 67.78% |
| Didecyl | Quaternary | 0.37% | 0.37% | 0.37% | 0.37% | 0.37% |
| Dimethyl | Amine | | | | | |
| | Compound | | | | | |
| Ammonium | | | | | | |
| Chloride | | | | | | |
| Isopropanol | Alcohol | 30.00% | 30.00% | 30.00% | 30.00% | 30.00% |
| Alcohol | | | | | | |
| Anhydrous | | | | | | |
| 1-Pentanol | Alcohol | 0.50% | 0.50% | 0.50% | 0.50% | 0.50% |
| Propylene | Solvent | 0.50% | 0.75% | 0.75% | 0.75% | 0.75% |
| glycol phenyl | | | | | | |
| ether | | | | | | |
| Alkyl | Nonionic | 0.30% | | | | |
| Polyglycoside | Surfactant | | | | | |
| Surfactant | | | | | | |
| Alkoxylated | Nonionic | | | | | 0.60% |
| Alcohol | Surfactant | | | | | |
| Secondary | Nonionic | | 0.60% | | | |
| alcohol | Surfactant | | | | | |
| ethoxylate | | | | | | |
| Sodium-n- | Anionic | | | | 0.60% | |
| octyl sulfate | Surfactant | | | | | |
| bio-based | Surfactant | | | 0.60% | | |
| ethoxylated | | | | | | |
| fatty alcohol | | | | | | |

TABLE 1F

| | | 026 | 027 | 028 | 029 | 030 |
|---|---|---|---|---|---|---|
| Water | | 67.39% | 67.69% | 67.94% | 67.82% | 67.94% |
| Alkyl Dimethyl & | Quaternary | 0.51% | 0.51% | 0.51% | 0.38% | 0.26% |
| Dimethyl | Amine | | | | | |
| Ammonium | Compound | | | | | |
| Chlorides | | | | | | |
| Isopropanol | Alcohol | 30.00% | 30.00% | 30.00% | 30.00% | 30.00% |
| Alcohol Anhydrous | | | | | | |
| 1-Pentanol | Alcohol | | | 0.50% | | |
| Propylene glycol | Solvent | | 1.50% | 0.75% | 1.50% | 1.50% |
| phenyl ether | | | | | | |
| 2-(hexyloxy)ethanol | Solvent | 1.78% | | | | |
| Alkyl | Nonionic | 0.29% | 0.30% | 0.30% | 0.30% | 0.30% |
| Polyglycoside | Surfactant | | | | | |
| Surfactant | | | | | | |
| Polysytrene/acrylate | Copolymer | 0.01% | | | | |
| copolymer | | | | | | |
| Polyacrylic Acid | Polymer | 0.025% | | | | |
| Polymer | | | | | | |

TABLE 1G

| | | 031 | 032 | 034 | 035 |
|---|---|---|---|---|---|
| Water | | 67.92% | 68.01% | 67.88% | 72.83% |
| Didecyl | Quaternary | 0.28% | 0.19% | 0.32% | 0.37% |
| Dimethyl | Amine | | | | |
| Ammonium | Compound | | | | |
| Chloride | | | | | |
| Isopropanol | Alcohol | 30.00% | 30.00% | 30.00% | 25.00% |
| Alcohol | | | | | |
| Anhydrous | | | | | |
| Propylene | Solvent | 1.50% | 1.50% | 1.50% | 1.50% |
| glycol phenyl | | | | | |
| ether | | | | | |
| Alkyl | Nonionic | 0.30% | 0.30% | 0.30% | 0.30% |
| Polyglycoside | Surfactant | | | | |
| Surfactant | | | | | |

TABLE 1H

| | | 036 | 037 | 038 | 039 | 040 |
|---|---|---|---|---|---|---|
| Water | | 67.82% | 67.76% | 72.69% | 67.68% | 67.47% |
| Didecyl Dimethyl | Quaternary | 0.37% | | | | 0.43% |
| Ammonium | Amine | | | | | |
| Chloride | Compound | | | | | |
| Alkyl Dimethyl & | Quaternary | | 0.44% | 0.51 | 0.51% | |
| Dimethyl | Amine | | | | | |
| Ammonium | Compound | | | | | |
| Chlorides | | | | | | |
| Isopropanol | Alcohol | 30.00% | 30.00% | 25.00% | 30.00% | 30.00% |
| Alcohol Anhydrous | | | | | | |
| Propylene glycol | Solvent | 1.50% | 1.50% | 1.50% | 1.50% | 1.50% |
| phenyl ether | | | | | | |
| Alkyl | Nonionic | 0.30% | 0.30% | 0.30% | 0.30% | 0.30% |
| Polyglycoside | Surfactant | | | | | |
| Surfactant | | | | | | |
| Sodium-n-octyl | Anionic | | | | | 0.30% |
| sulfate | Surfactant | | | | | |
| Polysytrene/acrylate | Copolymer | 0.0095% | | | 0.0095% | |
| copolymer | | | | | | |

TABLE 1I

| | | 041 | 042 | 043 | 044 | 045 |
|---|---|---|---|---|---|---|
| Water | | 77.69% | 77.68% | 76.69% | 76.68% | 67.69% |
| Didecyl Dimethyl | Quaternary | 0.50% | | 0.50% | | |
| Ammonium | Amine | | | | | |
| Chloride | Compound | | | | | |
| Alkyl Dimethyl & | Quaternary | | 0.51% | | 0.51% | 0.51% |
| Dimethyl | Amine | | | | | |
| Ammonium | Compound | | | | | |
| Chlorides | | | | | | |
| Isopropanol | Alcohol | 20.00% | 20.00% | 20.00% | 20.00% | 30.00% |
| Alcohol Anhydrous | | | | | | |
| Propylene glycol | Solvent | 1.50% | 1.50% | 1.50% | 1.50% | 1.50% |
| phenyl ether | | | | | | |
| 2-(hexyloxy)ethanol | Solvent | | | 1.00% | 1.00% | |
| Alkyl | Nonionic | 0.30% | 0.30% | 0.30% | 0.30% | 0.30% |
| Polyglycoside | Surfactant | | | | | |
| Surfactant | | | | | | |
| Polysytrene/acrylate | Copolymer | 0.0095% | 0.0095% | 0.0095% | 0.0095% | |
| copolymer | | | | | | |

TABLE 1J

| | | 046 | 047 | 048 | 049 | 050 |
|---|---|---|---|---|---|---|
| Water | | 67.69% | 66.69% | 66.68% | 66.68% | 65.86% |
| Didecyl Dimethyl | Quaternary | | 0.50% | | | 0.50% |
| Ammonium | Amine | | | | | |
| Chloride | Compound | | | | | |
| Alkyl Dimethyl & | Quaternary | 0.51% | | 0.51% | 0.51% | |
| Dimethyl | Amine | | | | | |
| Ammonium | Compound | | | | | |
| Chlorides | | | | | | |
| Isopropanol | Alcohol | 30.00% | 30.00% | 30.00% | 30.00% | 30.00% |
| Alcohol Anhydrous | | | | | | |
| Propylene glycol | Solvent | 1.50% | 1.50% | 1.50% | 1.50% | 1.50% |
| phenyl ether | | | | | | |
| 2-(hexyloxy)ethanol | Solvent | | 1.00% | 1.00% | 1.00% | 1.83% |
| Alkyl | Nonionic | 0.30% | 0.30% | 0.30% | 0.30% | 0.30% |
| Polyglycoside | Surfactant | | | | | |
| Surfactant | | | | | | |
| Polysytrene/acrylate | Copolymer | | 0.0095% | 0.0095% | 0.0095% | 0.0095% |
| copolymer | | | | | | |

TABLE 1K

| | | 051 | 052 | 053 | 054 | 055 |
|---|---|---|---|---|---|---|
| Water | | 67.35% | 67.25% | 65.46% | 65.86% | 70.86% |
| Alkyl Dimethyl & | Quaternary | 0.51% | 0.61% | 0.51% | 0.51% | 0.51% |
| Dimethyl | Amine | | | | | |
| Ammonium | Compound | | | | | |
| Chlorides | | | | | | |
| Citric Acid | Organic | | | 0.40% | | |
| | Acid | | | | | |
| Isopropanol Alcohol | Alcohol | 30.00% | 30.00% | 30.00% | 30.00% | 25.00% |
| Anhydrous | | | | | | |
| Propylene glycol | Solvent | | | 1.5000% | 1.5000% | 1.5000% |
| phenyl ether | | | | | | |
| 2-(hexyloxy)ethanol | Solvent | 1.83% | 1.83% | 1.8300% | 1.83% | 1.8300% |
| Alkyl Polyglycoside | Nonionic | 0.30% | 0.30% | 0.30% | 0.30% | 0.30% |
| Surfactant | Surfactant | | | | | |
| Polysytrene/acrylate | Copolymer | 0.0095% | 0.0095% | | | |
| copolymer | | | | | | |

TABLE 1L

| | | 056 | 057 | 058 | 059 | 060 |
|---|---|---|---|---|---|---|
| Water | | 64.85% | 65.76% | 64.86% | 64.86% | 62.86% |
| Alkyl Dimethyl & | Quaternary | 0.51% | 0.61% | 0.51% | 0.51% | 0.51% |
| Dimethyl | Amine | | | | | |
| Ammonium | Compound | | | | | |
| Chlorides | | | | | | |
| Isopropanol | Alcohol | 30.00% | 30.00% | 30.00% | 30.00% | 30.00% |
| Alcohol Anhydrous | | | | | | |
| Propylene glycol | Solvent | 1.5000% | 1.5000% | 1.5000% | 1.5000% | 1.5000% |
| phenyl ether | | | | | | |
| 2-(hexyloxy)ethanol | Solvent | 1.8300% | 1.8300% | 1.8300% | 1.8300% | 1.8300% |
| 1,2-Hexanediol | Solvent | | | | 1.00% | 3.00% |
| 1,2-Octanediol | Solvent | | | 1.00% | | |
| Alkyl | Nonionic | | | 0.30% | 0.30% | 0.30% |
| Polyglycoside | Surfactant | | | | | |
| Surfactant | | | | | | |
| decylamine oxide | Amphoteric | 0.30% | 0.30% | | | |
| | surfactant | | | | | |
| Polysytrene/acrylate | Copolymer | 0.0095% | | | | |
| copolymer | | | | | | |

TABLE 1M

| | | 061 | 062 | 063 | 064 | 065 |
|---|---|---|---|---|---|---|
| Water | | 64.46% | 65.86% | 65.46% | 65.26% | 65.36% |
| Alkyl Dimethyl & | Quaternary | 0.51% | 0.51% | 0.51% | 0.61% | 0.61% |
| Dimethyl | Amine | | | | | |
| Ammonium | Compound | | | | | |
| Chlorides | | | | | | |
| Citric Acid | Organic | 0.40% | | 0.40% | 0.40% | 0.40% |
| | Acid | | | | | |
| Octanoic Acid | Fatty Acid | | | | 0.099% | |
| Isopropanol | Alcohol | 30.00% | 30.00% | 30.00% | 30.0000% | 30.0000% |
| Alcohol Anhydrous | | | | | | |
| Propylene glycol | Solvent | 1.5000% | | 1.5000% | 1.5000% | 1.5000% |
| phenyl ether | | | | | | |
| 2- | Solvent | 1.8300% | 1.8300% | 1.8300% | 1.8300% | 1.8300% |
| (hexyloxy)ethanol | | | | | | |
| Ethylene glycol | Solvent | | 1.50% | | | |
| phenyl ether | | | | | | |
| Alkyl | Nonionic | 0.30% | 0.30% | | 0.30% | 0.30% |
| Polyglycoside | Surfactant | | | | | |
| Surfactant | | | | | | |
| decylamine oxide | Amphoteric | | | 0.30% | | |
| | Surfactant | | | | | |

TABLE 1N

| | | 066 | 067 | 068 | 069 | 070 |
|---|---|---|---|---|---|---|
| Water | | 65.26% | 65.37% | 70.26% | 65.26% | 65.27% |
| Didecyl Dimethyl | Quaternary | | 0.50% | | | 0.60% |
| Ammonium | Amine | | | | | |
| Chloride 50% | Compound | | | | | |
| Alkyl Dimethyl & | Quaternary | 0.61% | | 0.61% | 0.61% | |
| Dimethyl | Amine | | | | | |
| Ammonium | Compound | | | | | |
| Chlorides | | | | | | |
| Citric Acid | Organic | 0.40% | 0.40% | 0.40% | 0.40% | 0.40% |
| | Acid | | | | | |
| Octanoic Acid | Fatty Acid | 0.099% | 0.099% | 0.099% | 0.099% | 0.099% |
| Isopropanol | Alcohol | 30.0000% | 30.0000% | 25.0000% | 30.0000% | 30.0000% |
| Alcohol | | | | | | |
| Anhydrous | | | | | | |
| Propylene glycol | Solvent | 1.5000% | 1.5000% | 1.5000% | 1.5000% | 1.5000% |
| phenyl ether | | | | | | |
| 2- | Solvent | 1.8300% | 1.8300% | 1.8300% | 1.8300% | 1.8300% |
| (hexyloxy)ethanol | | | | | | |
| Alkyl | Nonionic | 0.30% | 0.30% | 0.30% | 0.30% | 0.30% |
| Polyglycoside | Surfactant | | | | | |
| Surfactant | | | | | | |

TABLE 1O

| | | 071 | 072 | 073 | 074 | 075 |
|---|---|---|---|---|---|---|
| Water | | 65.26% | 65.27% | 64.27% | 65.26% | 65.26% |
| Didecyl Dimethyl | Quaternary | | 0.60% | 0.60% | | |
| Ammonium | Amine | | | | | |
| Chloride 50% | Compound | | | | | |
| Alkyl Dimethyl & | Quaternary | 0.61% | | | 0.61% | 0.61% |
| Dimethyl | Amine | | | | | |
| Ammonium | Compound | | | | | |
| Chlorides | | | | | | |
| Citric Acid | Organic | 0.40% | 0.40% | 0.40% | 0.40% | 0.40% |
| | Acid | | | | | |
| Octanoic Acid | Fatty Acid | 0.099% | 0.099% | 0.099% | 0.099% | 0.099% |
| Isopropanol | Alcohol | 30.0000% | 30.0000% | 30.0000% | 30.0000% | 30.0000% |
| Alcohol | | | | | | |
| Anhydrous | | | | | | |
| Propylene glycol | Solvent | 1.5000% | 1.5000% | 1.5000% | 1.5000% | 1.5000% |
| phenyl ether | | | | | | |
| 2- | Solvent | 1.8300% | 1.8300% | 1.8300% | 1.8300% | 1.8300% |
| (hexyloxy)ethanol | | | | | | |
| Propylene glycol | Solvent | | | 1.00% | | |
| Alkyl | Nonionic | 0.30% | 0.30% | 0.30% | 0.30% | 0.30% |
| Polyglycoside | Surfactant | | | | | |
| Surfactant | | | | | | |

TABLE 1P

| | | 076 | 077 | 078 | 079 | 080 |
|---|---|---|---|---|---|---|
| Water | | 65.56% | 65.28% | 65.77% | 65.82% | 65.97% |
| Alkyl Dimethyl & | Quaternary | 0.61% | 0.61% | 0.60% | 0.60% | 0.60% |
| Dimethyl | Amine | | | | | |
| Ammonium | Compound | | | | | |
| Chlorides | | | | | | |
| Citric Acid | Organic | | 0.40% | 0.40% | 0.40% | |
| | Acid | | | | | |
| Pyruvic Acid | Organic | | | | | 0.30% |
| | Acid | | | | | |
| Phosphoric Acid | Inorganic | 0.099% | | | | |
| | Acid | | | | | |
| Octanoic Acid | Fatty Acid | 0.099% | 0.079% | | | |
| Lauric Acid | Fatty Acid | | | 0.098% | | |
| Myristic Acid | Fatty Acid | | | | 0.05% | |
| Isopropanol | Alcohol | 30.0000% | 30.0000% | 29.5000% | 29.5000% | 29.5000% |
| Alcohol | | | | | | |
| Anhydrous | | | | | | |
| Propylene glycol | Solvent | 1.5000% | 1.5000% | 1.5000% | 1.5000% | 1.5000% |
| phenyl ether | | | | | | |
| 2- | Solvent | 1.8300% | 1.8300% | 1.8300% | 1.8300% | 1.8300% |
| (hexyloxy)ethanol | | | | | | |
| Alkyl | Nonionic | 0.30% | 0.30% | 0.30% | 0.30% | 0.30% |
| Polyglycoside | Surfactant | | | | | |
| Surfactant | | | | | | |

TABLE 1Q

| | | 081 | 082 | 083 | 084 | 085 |
|---|---|---|---|---|---|---|
| Water | | 65.27% | 66.70% | 64.87% | 67.70% | 65.70% |
| Alkyl Dimethyl & | Quaternary | 0.60% | 0.60% | 0.60% | 0.60% | 0.60% |
| Dimethyl | Amine | | | | | |
| Ammonium | Compound | | | | | |
| Chlorides | | | | | | |
| Citric Acid | Organic | 1.0000% | 0.40% | 0.40% | 0.40% | 0.40% |
| | Acid | | | | | |
| Isopropanol | Alcohol | 29.5000% | 29.5000% | 29.5000% | 29.5000% | 29.5000% |
| Alcohol | | | | | | |
| Anhydrous | | | | | | |
| Propylene glycol | Solvent | 1.5000% | 1.5000% | 1.5000% | 1.5000% | 1.5000% |
| phenyl ether | | | | | | |
| 2- | Solvent | 1.8300% | | 1.8300% | | |
| (hexyloxy)ethanol | | | | | | |
| Propylene glycol | Solvent | | 1.00% | 1.00% | | 2.00% |
| Alkyl | Nonionic | 0.30% | 0.30% | 0.30% | 0.30% | 0.30% |
| Polyglycoside | Surfactant | | | | | |
| Surfactant | | | | | | |

Samples of the above formulations were tested for antimicrobial efficacy against a number of target microbes (e.g., Candida auris and Staphylococcus aureus with or without soil). The below discussion describes the efficacy of the above formulations against the target microbes in various environments.

First, samples of formulations described above were tested against C. auris dosed on sheets per applicable EPA guidelines. For towelette product (wipes), such method requires testing the liquid extracted from the wipe against C. auris using a quantitative method. The efficacy of the liquid extracted from different substrates versus the lotion used for dosing were compared. The sheets were made from either PET, spunlace non-woven (PET/pulp/PET sandwich structure), a hybrid non-woven substrate formed by polypropylene and wood pulp, or a spunlace non-woven substrate formed by PET and Rayon. Testing was conducted over time periods of 15 seconds, 30 seconds, and 55 seconds. To pass, the formula must have had at least a 5-log reduction in the population of the target microbe.

Regarding the test of C. auris dosed on a PET sheet with a contact time of 15 seconds, formula 005 failed. Regarding the test of C. auris dosed on a PET sheet with a contact time of 30 seconds, formula 005 failed and formulas 045-048 passed. Regarding the test of C. auris dosed on a PET sheet with a contact time of 55 seconds, formulas 041-044 failed.

Regarding the test of C. auris dosed on a spunlace sheet with a contact time of 15 seconds, formula 005 failed. Regarding the test of C. auris dosed on a spunlace sheet with a contact time of 30 seconds, formula 005 passed.

Regarding the test of C. auris dosed on a polypropylene+pulp substrate with a contact time of 15 seconds, formula 005 passed. Regarding the test of C. auris dosed on a polypropylene+pulp substrate with a contact time of 30 seconds, formulas 005, 019, and 027 passed, formulas 036, 037, and 039 barely passed, formulas 023, 030, and 035 failed, and formulas 020-022, 024-026, 028, 029, 031, and 032 barely failed. Regarding the test of C. auris dosed on a polypropylene+pulp substrate with a contact time of 55 seconds, formulas 032 and 037 passed.

Regarding the test of C. auris dosed on a spunlace non-woven substrate formed from PET and Rayon. with a contact time of 15 seconds, formula 019 passed, formula 029 barely failed, and formula 005 failed. Regarding the test of C. auris dosed on a spunlace non-woven substrate formed by PET and Rayon. with a contact time of 30 seconds, formula 005 barely passed.

Second, samples of formulations described above were tested against C. auris, with the lotion only (no substrate), over contact times of 15 seconds, 25 seconds, 30 seconds, 55 seconds, 1 minute, 2 minutes, 3 minutes and 5 minutes. To pass, the formula must have had at least a 5-log reduction in the C. auris population.

Regarding the test against C. auris with a contact time of 15 seconds, formula 005 passed and formulas 016-018 failed. Regarding the test against C. auris with a contact time of 25 seconds, formula 005 passed and formula 018 failed. Regarding the test against C. auris with a contact time with a contact time of 25 seconds with extra soil (i.e. 120% soil load), formula 037 passed. Regarding the test against C. auris with a contact time of 30 seconds, formulas 005, 012, 014, 016, and 017 passed and formulas 013 failed. Regarding the test against C. auris with a contact time of 55 seconds with extra soil, formula 037 passed. Regarding the test against C. auris with a contact time of 1 minute, formulas 005 and 012-014, passed and formulas 004, 006, 007, and 018 failed. Regarding the test against C. auris with a contact time of 2 minutes, formulas 003, 005, and 012-014, passed and formulas 004, 006, 007, failed. Regarding the test against C. auris with a contact time of 3 minutes, formulas 005 passed, formula 007 failed, and formulas 004 and 006 barely failed. Regarding the test against C. auris with a contact time of 5 minutes, formula 004 passed.

Third, samples of formulations described above were tested against Staphylococcus aureus in a 10 carrier test. The tests were performed using a polypropylene+pulp substrate, a PET sheet, and a spunlace sheet. The polypropylene+pulp sheet had a loading ratio of 4.5, the PET sheet was 7 inches by 7 inches and had a loading ratio of 4.5, and the spunlace sheet was 7 inches by 8 inches and had a loading ratio of 4.75. The tests were performed over 50 seconds for each loaded sheet.

Regarding the polypropylene+pulp sheet, formulas 005, 027, 037, 039, and 040 failed with 6 positives while formulas 042, 044, 046, and 048 passed with 0 positives. Regarding the PET sheet, formula 005 (2 positives) failed. Regarding the spunlace sheet, formulas 005 (7 positives), 027 (7 positives), 037 (6 positives), and 039 (10 positives), failed.

Lastly, samples of formulations described above were tested against Staphylococcus aureus in a 60 carrier test with a 5.0 loading ratio in a donut configuration. The PET sheet was either 7 inches by 8 inches and 52 gsm, 6 inches by 5 inches and 52 gsm, or 6 inches by 6.25 inches and 40 gsm. The tests were performed using a PET sheet with a 45 second contact time. Results are shown in Table 2.

TABLE 2

| | PET 7″ × 8″ | PET 7″ × 8″ | PET 6″ × 5″ | PET 6″ × 6.25″ |
|---|---|---|---|---|
| | 52 gsm (Staph) | 52 gsm (Pseudo) | 52 gsm | 40 gsm |
| 050 | Failed (6/60) | | | |
| 051 | Failed (14/60) | | | |
| 052 | Failed (18/60) | | | |
| 053 | Failed (3/60) | | | |
| 054 | Failed (20/60) | | | |
| 055 | Failed (12/60) | | | |
| 057 | Failed (11/60) | | | |
| 058 | Failed (15/60) | | | |
| 059 | Failed (7/60) | | | |
| 060 | Failed (26/60) | | | |
| 062 | Failed (34/60) | | | |
| 063 | Failed (6/60) | | | |
| 064 | Passed (0/60) | | | |
| 065 | Failed (4/60) | | | |
| 066 | | Passed (1/60) | | |
| 067 | Failed (4/60) | | | |
| 068 | Passed (1/60) | | | |
| 069 | | | Passed (0/60) | |
| 070 | | Passed (0/60) | | |
| 071 | | | | Passed (1/60) |
| 072 | Passed (1/60) | | | |
| 073 | | | Passed (0/60) | |
| 076 | Failed (3/60) | | | |
| 077 | Passed (0/60) | Passed (0/60) | | |
| 078 | Passed (1/60) | Failed (3/60) | | |
| 079 | Failed (3/60) | | | |
| 080 | Failed (6/60) | | | |
| 081 | Failed (8/60) | | | |
| 082 | Passed (1/60) | Passed (0/60) | | |
| 083 | Passed (0/60) | Passed (1/60) | | |
| 084 | Passed (0/60) | Failed (2/60) | | |
| 085 | Passed (0/60) | Passed (0/60) | | |

Based on the results from Table 2, formulas 64 and 66 (which was identical to formula 64, just formulated on a different day), formula 82, and formula 85 are the three examples that passed Staph, Pseudomonas, and C. auris at 45 sec, which is very challenging to achieve. By way of example, formula 085 includes 0.61% alkyl dimethyl and dimethyl ammonium chlorides, 0.40% citric acid, 29.5% isopropanol alcohol anhydrous, 1.5% propylene glycol phenyl ether, 2.0% propylene glycol, and 0.3% alkyl polyglycoside surfactant. Example formula 085 includes less than 40%, and even less than 30% alcohol content which lowers the flammability and toxicity rating. The formulation achieves at least a 3-log reduction against a Staph. aureus population within 2 minutes. The addition of citric acid may also act as a buffer lowering the overall pH to be within the ranges described herein.

Without departing from the spirit and scope of this invention, one of ordinary skill can make various modifications to the invention to adapt it to various usages and conditions. As such, these changes and modifications are properly, equitably, and intended to be, within the full range of equivalence of the following claims.

What is claimed:

1. A pre-loaded cleaning wipe comprising:
(A) a non-woven substrate; and
(B) a formulation loaded onto the substrate comprising:
(i) about 10% to about 40% by weight of an alcohol;
(ii) about 0.01% to less than 0.7% by weight of a quaternary amine compound;
(iii) about 0.1% to about 2% by weight of a surfactant;
(iv) optionally, one or more adjuncts comprising at least one of: fragrance, colorant, solvent, polymer, acid, water, pH adjusting agents or any mixture or combination thereof; and
wherein the formulation exhibits at least a 3-log reduction in a Staphylococcus aureus population within 2 minutes.

2. The pre-loaded cleaning wipe of claim 1, wherein the formulation further comprises a glycol ether solvent.

3. The pre-loaded cleaning wipe of claim 1, wherein the formulation includes about 25% to about 40% by weight of an alcohol.

4. The pre-loaded cleaning wipe of claim 1, wherein the formulation has a pH of about 1 to about 5.

5. The pre-loaded cleaning wipe of claim 1, wherein the formulation further comprises a fatty acid.

6. The pre-loaded cleaning wipe of claim 1, wherein the formulation further comprises an inorganic acid.

7. The pre-loaded cleaning wipe of claim 1, wherein the formulation further comprises an organic acid.

8. The pre-loaded cleaning wipe of claim 1, wherein the formulation exhibits at least a 5-log reduction in a Staphylococcus aureus population within 2 minutes.

9. The pre-loaded cleaning wipe of claim 1, wherein the formulation exhibits at least a 3-log reduction in a Candida auris population within 2 minutes.

10. A pre-loaded cleaning wipe comprising:
(A) a non-woven substrate; and
(B) a formulation loaded onto the substrate comprising:
(i) about 10% to less than 40% by weight of an alcohol;
(ii) about 0.01% to less than 1.5% by weight of a quaternary amine compound;
(iii) about 0.1% to about 2% by weight of a surfactant;
(iv) about 0.5% to about 5% by weight of a glycol ether;
(v) optionally, one or more adjuncts comprising at least one of: fragrance, colorant, solvent, polymer, acid, water, pH adjusting agents or any mixture or combination thereof; and
wherein the formulation exhibits at least a 3-log reduction in a Candida Auris population within 2 minutes.

11. The pre-loaded cleaning wipe of claim 10, wherein the formulation further comprises a fatty acid.

12. The pre-loaded cleaning wipe of claim 10, wherein the formulation includes about 25% to about 40% by weight of an alcohol.

13. The pre-loaded cleaning wipe of claim 10, wherein the formulation further comprises an inorganic acid.

14. The pre-loaded cleaning wipe of claim 10, wherein the formulation has a pH of about 1 to about 5.

15. The pre-loaded cleaning wipe of claim 10, wherein the formulation exhibits at least a 3-log reduction in a Staphylococcus aureus population within 2 minutes.

16. The pre-loaded cleaning wipe of claim 10, wherein the formulation exhibits at least a 5-log reduction in a Candida auris population within 2 minutes.

17. The pre-loaded cleaning wipe of claim 10, wherein the formulation further comprises an organic acid.

18. A pre-loaded cleaning wipe comprising:
(A) a non-woven substrate; and
(B) a formulation loaded onto the substrate comprising:
(i) about 25% to less than 40% by weight of an alcohol;
(ii) about 0.01% to less than 2.0% by weight of a quaternary amine compound;
(iii) about 0.1% to about 2% by weight of a surfactant;
(iv) about 0.5% to about 5% by weight of a glycol ether;
(v) optionally, one or more adjuncts comprising at least one of: fragrance, colorant, solvent, polymer, acid, water, pH adjusting agents or any mixture or combination thereof; and
wherein the formulation exhibits at least a 3-log reduction in a Staphylococcus aureus population within 2 minutes and has a pH of about 2 to about 4.

19. The pre-loaded cleaning wipe of claim 18, wherein the formulation further comprises octanoic acid.

18. re-loaded cleaning wipe of claim 18, wherein the formulation exhibits at least a 3-log reduction in Candida Auris population within 2 minutes.
